(19) United States
(12) Patent Application Publication
(10) Pub. No.: US 2012/0286730 A1
(43) Pub. Date: Nov. 15, 2012

(54) Automatic Recharging Robot for Electric and Hybrid Vehicles

(76) Inventor: Richard William Bonny, Redmond, WA (US)

(21) Appl. No.: 13/104,974

(22) Filed: May 11, 2011

(51) Int. Cl. H02J 7/00

(52) U.S. Cl. 320/109

(57) ABSTRACT

Systems and methods are disclosed for automatically recharging electric and plug-in hybrid vehicles. A deployment assembly (101) is permanently mounted to the underside of a vehicle and houses a robotic probe (102) that can be lowered to the ground by tether. The probe automatically navigates to a compatible recharging station (103), and inserts a plug to complete the charging circuit. Once charging is complete, the robotic probe is automatically retracted back into the deployment

### CROSS REFERENCE TO RELATED APPLICATIONS

This application claims the benefit of provisional patent application Ser. No. 61/395,065 filed 2010 May 10 by the present inventor.

### FEDERALLY SPONSORED RESEARCH

Not Applicable

### SEQUENCE LISTING

Not Applicable

### BACKGROUND

1. Field

The invention relates generally to electric powered cars and specifically to electric car charging systems. It also relates to navigable robotic devices.

2. Prior Art

Electric cars and plug-in hybrid vehicles currently represent a small segment of the automotive market and part of the reason for their limited adoption is the lack of charging infrastructure. While environmental and economic concerns are likely to drive future adoption of electrically powered vehicles, many of the issues associated with recharging the vehicles still need to be addressed to permit more widespread acceptance.

Commercial charging stations are far from ubiquitous and installation of current generation charging equipment is deterred by its expense and bulk.

Charging at home tends to be the most attractive option, but it too has drawbacks. While some vehicles may be charged from a standard outlet, this typically takes more than five hours to complete a full charge. Faster home charging systems that deliver more current are available, but these require that expensive equipment be installed.

In all home charging scenarios, drivers must currently connect charging cables manually to their vehicles and remember to remove the connection prior to using the vehicle. This can be inconvenient and obtrusive, as the connecting cable will typically present an obstacle to freely moving around the vehicle.

There are currently no widely available vehicle charging systems that are fully automatic. Attempts to develop such systems previously have been inhibited by the difficulty in precisely maneuvering a coupling mechanism in three dimensional space. Such experimental systems have tended to be very complex mechanically (and thus expensive). Furthermore, they are not easily adaptable to the wide variety of vehicle configurations that would need to be accommodated.

### ADVANTAGES

The proposed system offers significant advantages over existing manual and automatic recharging solutions. With daily recharging typically required for electric vehicles, it is a matter of convenience to be able to have this function performed automatically without user action. It also improves the reliability of the charging process by avoiding potentially unfortunate circumstances should the owner forget to recharge the vehicle (or forget to unplug the cable before driving off).

The solution described herein offers an unobtrusive configuration that obviates the need for charging apparatus that may consume significant valuable space. By accomplishing charging underneath the vehicle, it also eliminates dangling wires and other potentially troublesome obstacles. The vehicle itself can offer some protection for the charging equipment when it is positioned directly over the charging station.

By incorporating an intelligent, navigable device onboard the vehicle, the solution offers a variety of potential configurations for charging stations, including some very low cost options for home use. The system is capable of automatically detecting the presence and characteristics of compatible charging stations and making appropriate adjustments.

### SUMMARY

With concerns about climate change and the depletion of fossil fuel sources, it is likely that electric automobiles and plug-in hybrid vehicles will play a dramatically increasing role in meeting the world's future transportation needs. One issue adversely affecting the popular adoption of electric vehicles is the need for them to be frequently recharged. The invention presented herein greatly mitigates this inconvenience by defining a fully automatic system to perform this function.

A unique aspect of the solution presented by this device is its universality. Vehicles come in various sizes and shapes and engineering a solution to automatically couple the vehicle charging system with a generic external charging station presents significant challenges. These challenges are met by the proposed solution by accomplishing the coupling at ground level and reducing the problem space from three dimensions to only two. A unit installed on the underside of the vehicle deploys a robotic probe to ground level. It then automatically navigates to a position directly above the charging port and completes the coupling. The only variation from one vehicle to another is the ground clearance, which is easily addressed by controlling how much of a spooled tether needs to be unreeled to reach the ground.

### DRAWINGS

### Figures

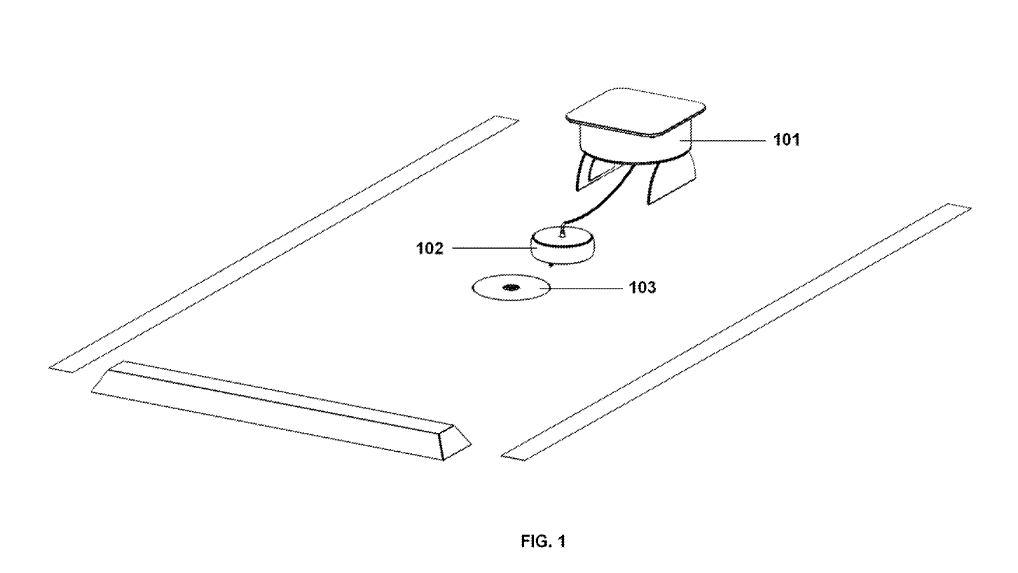

FIG. 1 shows an overview of the principal components of the charging system.

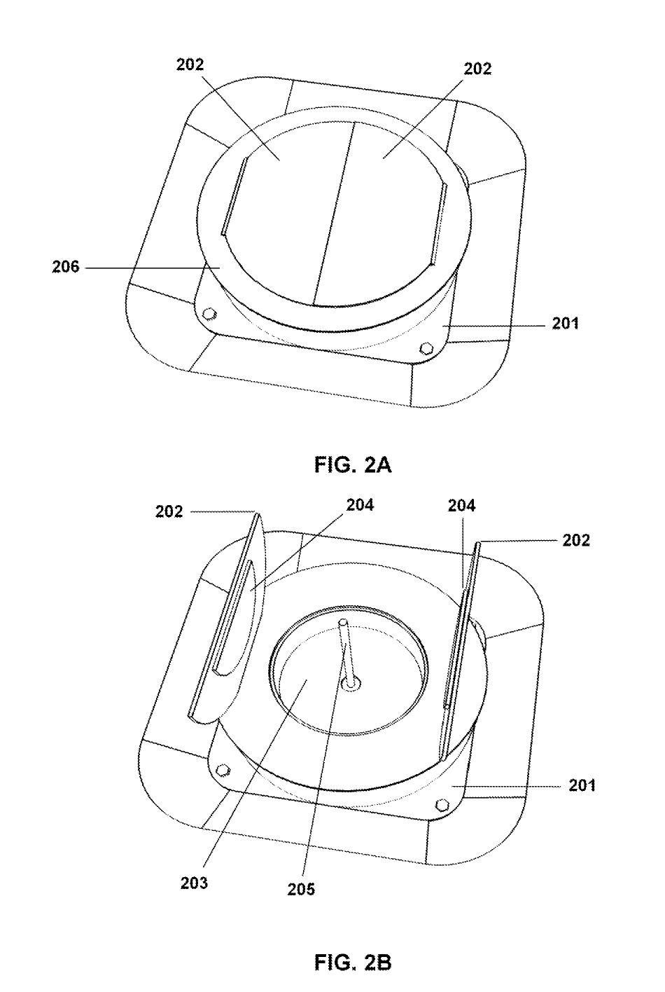

FIGS. 2A and 2B show the probe docking and deployment assembly in closed and open configurations, respectively.

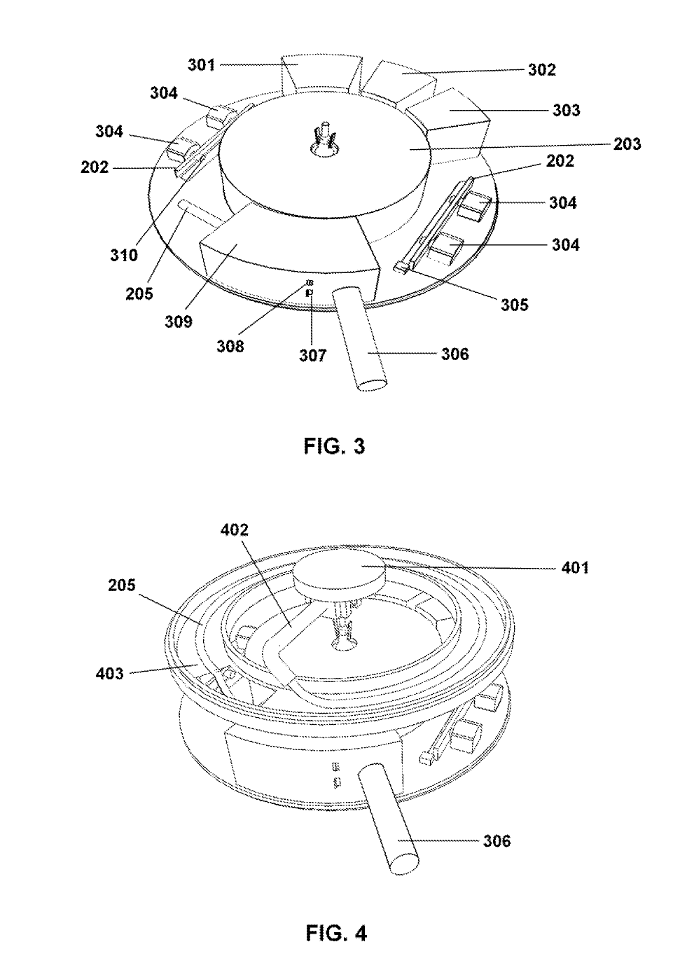

FIG. 3 shows the lower half of the deployment assembly as viewed from above.

FIG. 4 shows the deployment assembly from above, with the casing removed.

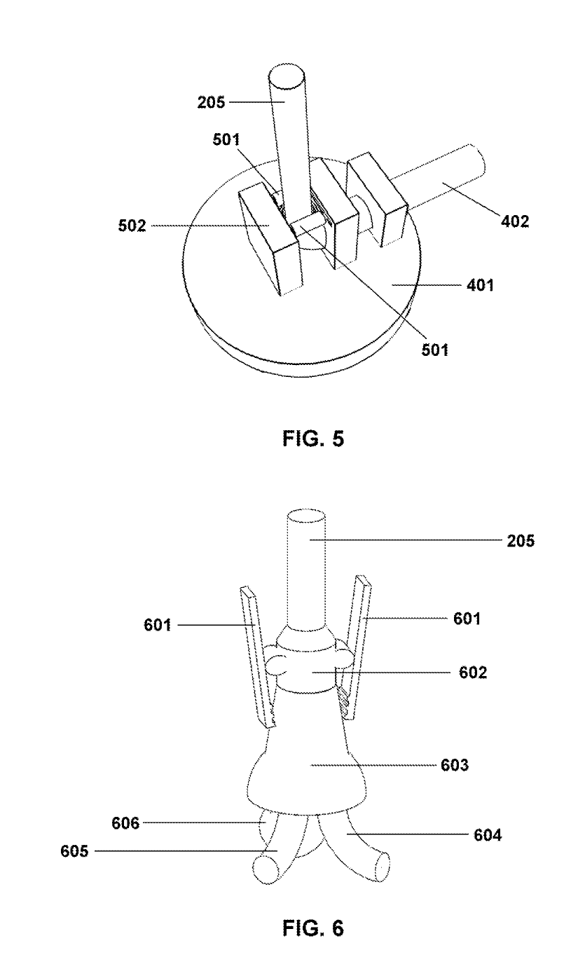

FIG. 5 shows a detailed view of the tether feed mechanism.

FIG. 6 shows the umbilical connector that joins the tether to the docking probe.

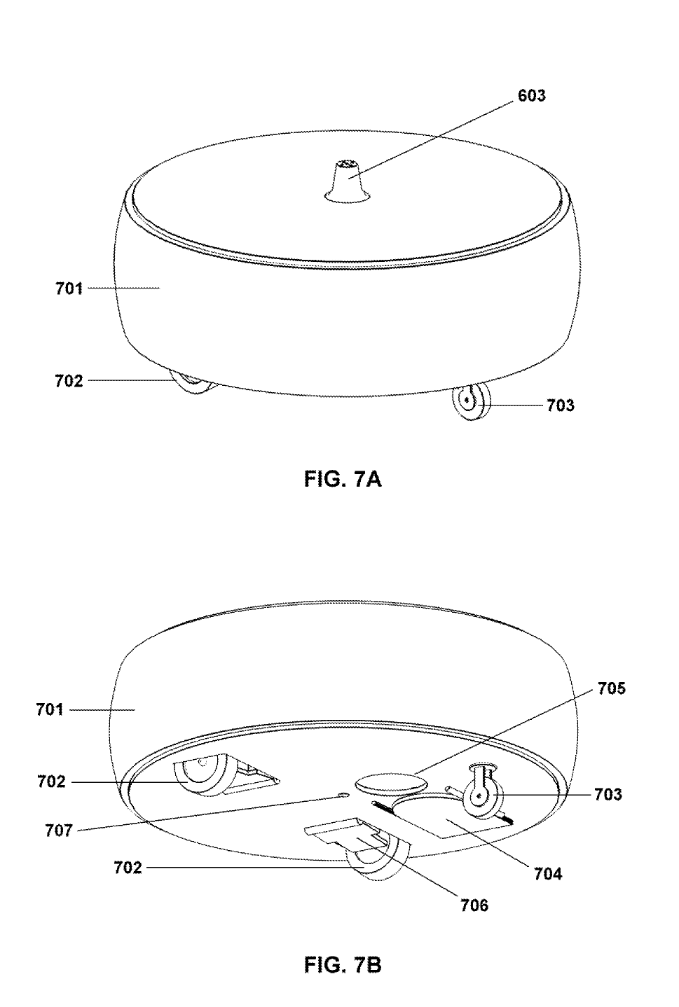

FIGS. 7A and 7B show a top and bottom view of the charging probe.

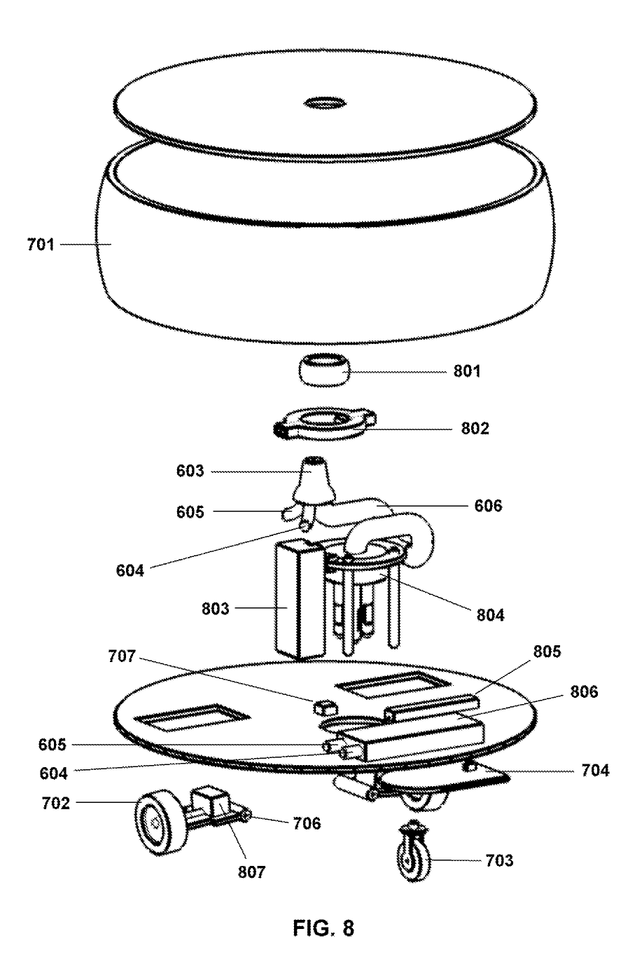

FIG. 8 presents an exploded view of the internal components of the charging probe.

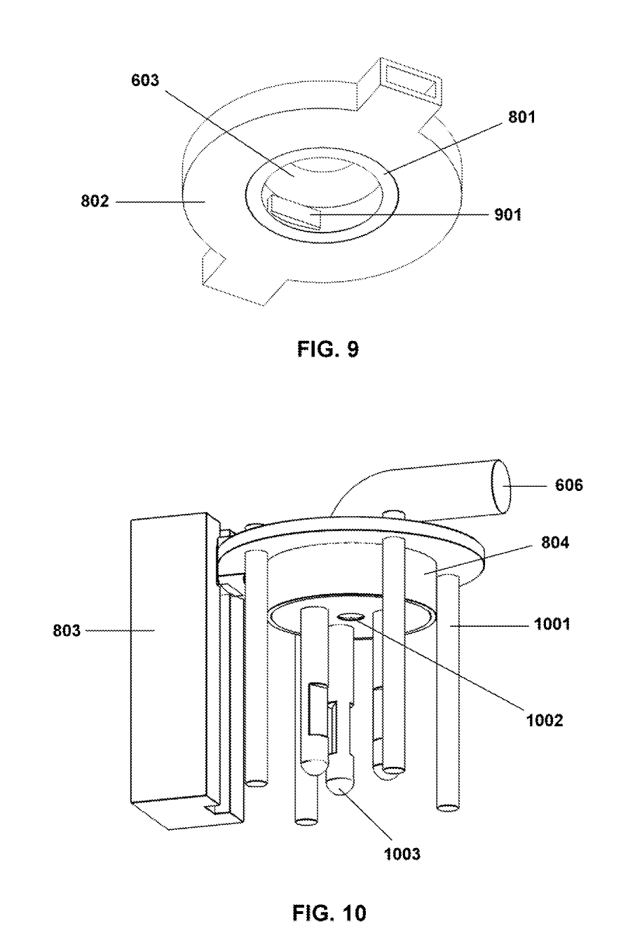

FIG. 9 shows a detailed view of the umbilical swivel.

FIG. 10 shows details of the retractable charging plug.

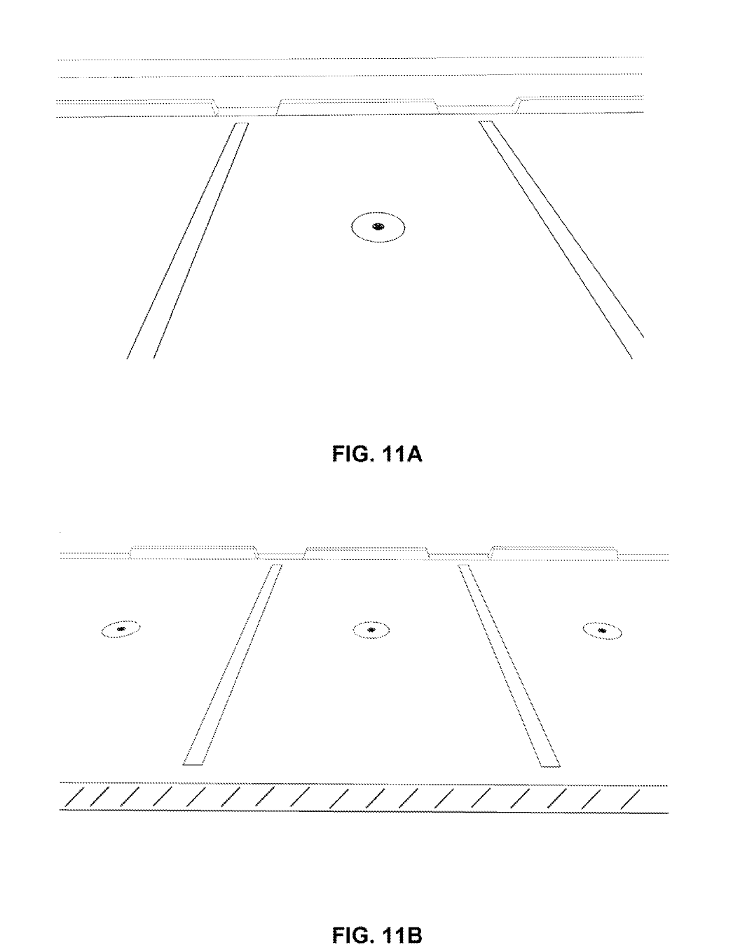

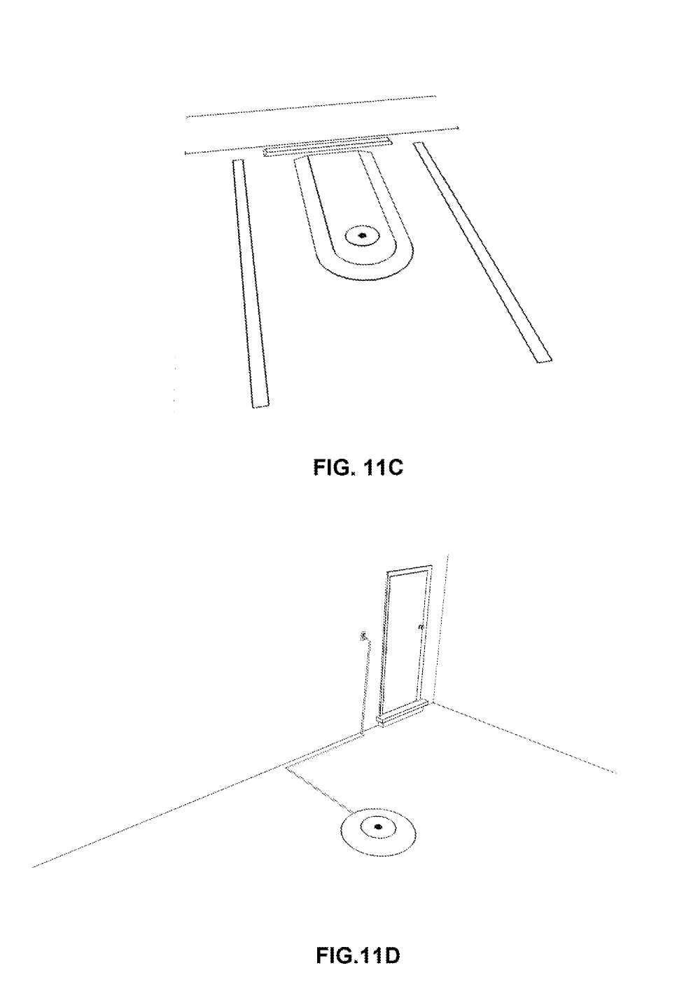

FIGS. 11A, 11B, 11C, and 11D show alternative embodiments of charging stations.

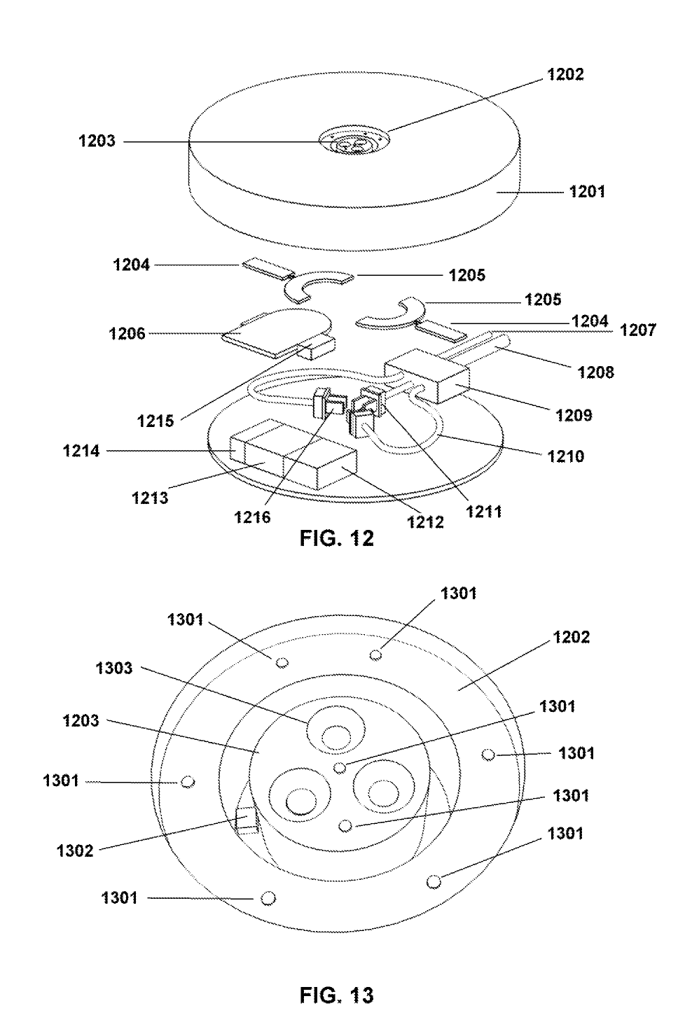

FIG. 12 presents an exploded view of the internal components of the charging station.

FIG. 13 presents a detailed view of the charging station docking port.

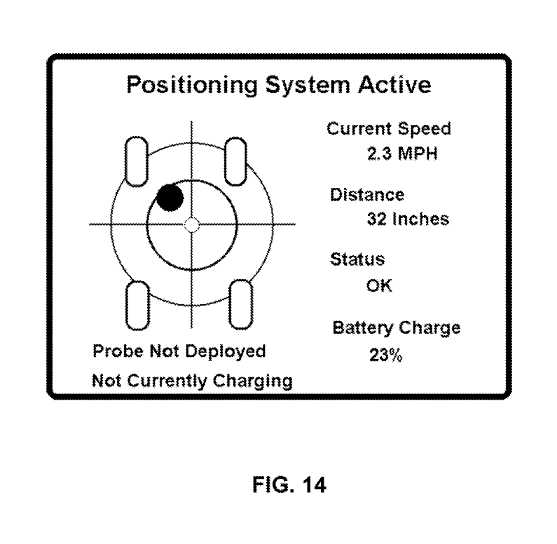

FIG. 14 shows a sample display for vehicle positioning feedback.

### DRAWINGS

### Reference Numerals

101 charging probe deployment assembly
102 robotic charging probe
103 charging station
201 deployment assembly mounting bracket
202 protective doors
203 probe stowage bay
204 bay door pads
205 umbilical tether
206 deployment assembly outer shell
301 control unit
302 communications module
303 unit battery
304 locking pin engagement switches
305 bay door motors
306 vehicle charging connector
307 vehicle data connector
308 vehicle power connector
309 transformer module
310 bay door locking pins
401 tether deployment motor
402 tether reel arm
403 tether spooling tray
501 tether feed rollers
502 feed roller mounting brackets
601 connector plug retaining clamps
602 umbilical connector plug
603 umbilical swivel connector
604 probe data cable extension
605 probe power cable extension
606 probe charging cable extension
701 probe outer shell
702 drive wheels
703 front wheel
704 probe retractable shield
705 plug deployment window
706 hinged wheel mountings
707 IR receiver
801 connector socket
802 collar lock
803 plug deployment motor
804 charging plug
805 probe shield switch
806 probe circuit board
807 drive wheel motors
901 color locking pin
1001 plug deployment rails
1002 probe docking camera
1003 plug electrical prongs
1201 outer casing
1202 charging station port
1203 charging outlet
1204 collar switches
1205 waterproof collar
1206 charging station access door
1207 station power cable
1208 charging cable
1209 charging cable activation switch
1210 charging plug wires
1211 plug retaining clamps
1212 charging station communications module
1213 charging station control unit
1214 Internet link
1215 access door motor
1301 infrared LED emitters
1302 moisture detector
1303 charging outlet receptacles

### DETAILED DESCRIPTION

One embodiment of the charging system is illustrated in FIG. 1. The principal components are a docking and deployment assembly (101), a maneuvering robotic probe (102), and a charging station (103). The deployment assembly (101) is mounted to the underside of an electric or plug-in hybrid motor vehicle (not shown). It deploys the tethered robotic probe (102) which automatically docks with a compatible electric charging station (103).

### Docking and Deployment Assembly

The docking and deployment assembly (101, also referred to as the probe deployment assembly) is the complete housing that is mounted on the underside of the vehicle. FIG. 2A shows an embodiment of the assembly in a closed position. It is securely bolted to the vehicle frame by way of a mounting bracket (201). Specific mounting hardware may vary from vehicle to vehicle and some vehicles may be specifically designed to accommodate a suitable installation configuration. A set of secure bay doors (202) retain the charging probe safely and securely within the assembly while the vehicle is in motion or not currently in the process of recharging.

FIG. 2B illustrates the embodiment of the deployment assembly with the bay doors (202) in an open position. An umbilical tether (205) drops from the assembly to lower the robotic probe (not shown) to the ground. The umbilical tether serves the dual purpose of housing the critical connecting cables to the probe and providing the physical support for lowering and raising the probe from the housing to the ground. It should be a strong, lightweight, and flexible sheath. The view of the tether is truncated in FIG. 2B and would actually be connected to the probe

Prior to deployment, the probe rests securely in a probe stowage bay (203). The bay doors in this embodiment have attached pads (204) to aid in protecting and securing the probe while it is in the bay. An outer casing (206) provides a rugged shell that protects the deployment assembly and its contents. Once closed, the bay doors (202) help secure the probe in position and protect it from any road dirt, moisture, or debris

FIG. 3 shows the lower portion of the inner components of the deployment assembly. The vehicle battery charging cable connects to the unit via the transformer module (309). A plug connector (306) attaches through a cutout in the outer casing (not shown in this partial view). The transformer module (309) performs whatever conversions may be required to properly match the electrical format of the vehicle battery charging system to the standards defined for charging stations. This may be a vehicle-specific unit with a custom plug connector. The appropriate unit can be swapped into position as required. This is the only component of the entire charging system that might be vehicle-specific, although it is also quite likely that a single variant of the transformer module (309) would service multiple vehicle models.

A control unit (301) serves as the “brains” of the entire system and makes all calculations relating to probe deployment and navigation. It accepts inputs from various sensors, both in the deployment assembly (101) and the robotic probe (102). It provides information to the driver and accepts any required driver input such as payment information for commercial charging stations. It contains a microprocessor, memory, and persistently stored information and software to facilitate all required functions. The exact specifications are subject to final engineering decisions, but the unit is typical of similar control units in other robotic devices.

A communications module (302) contains a wireless transmitter/receiver. One embodiment would be to use a device conforming to the BlueTooth standard, although other embodiments might implement proprietary formats. It communicates with charging stations. Collected messages are reported to the control unit (301), which is also responsible for determining the requirements and contents for any transmitted messages.

The communications module (302) may also communicate with an onboard remote control panel or device, depending on whether a wired or wireless connection is used as the principal user interface to the system.

The deployment assembly houses a unit battery (303). All charging system functions are powered by this rechargeable battery. The system can therefore operate completely independently of the vehicle power systems, except to the extent that those are required to recharge the unit battery over time. The capacity requirement of the battery should be modest, since it only needs to power probe deployment, which will normally take less than 30 seconds. The system then remains in an unpowered state, typically for multiple hours, while the vehicle battery is recharging. It then spends another 30 seconds or so retracting the probe back into the housing assembly. This cycle will generally occur once per day.

These requirements are far less demanding than, say, a robotic cleaning device that must operate continuously for a period of 45 minutes to an hour on a single battery charge.

In order to recharge the unit battery (303) over time, a standard auto electrical connector (308) is provided. The power source is not the primary electric vehicle drive battery, but the auxiliary battery that powers vehicle accessories.

Some embodiments may contain a vehicle data connector (307). This connector is optional, as the charging system can alternatively communicate with the vehicle via a wireless connection (via the communications module 302). For vehicles that prefer to implement a wired connection, this is most likely a USB-compliant connector that would permit the primary vehicle computer/navigation system to treat the charging system as a peripheral device.

When retracting the probe, the contact points within the stowage bay (203) are a set of spring-loaded hinged pads (not pictured). This ensures a secure holding position and contact sensors on the hinged pads provide a positive feedback mechanism for successful retraction and stowage.

The two motor-driven doors (202) constitute the bottom barrier of the stowage bay (203). A pair of bay door motors (305) opens and closes the doors. The two doors have slightly overlapping lips, so the open/close sequence requires one door motor to engage slightly before the other. The overlapping lips contain inverse detents so that the closed position results in a flush surface.

When in the closed position, a set of four locking pins (310) insert into holes in the vertical bend of the bay doors. This provides extra security to ensure that the doors remain closed when the vehicle is in motion. This helps protect and retain the robotic probe within the stowage bay. Note that even if the doors were to open somehow, the probe is still held firmly in place by the retracted umbilical tether.

The bay door locking pins (310) are inserted and retracted into corresponding bay door holes via a set of locking pin engagement switches (304). One embodiment of such a mechanism would be a simple solenoid switch.

FIG. 4 shows an embodiment of the additional components of the deployment assembly, although the outer shell is still omitted in order to expose the other components.

A tether spooling tray (403) holds the full length of the umbilical tether (205) when the charging probe is retracted. Only one to one-and-a-half loops of the tether is likely to be required to provide sufficient tether length to accommodate all vehicles.

A vehicle charging cable (not individually depicted) is the electrical connector that will carry the charging current from the charging station to the primary vehicle battery. It emerges from the transformer module (309) and is contained within the core of the umbilical tether (205).

A probe power cable (not individually depicted) is also housed within the core of the umbilical tether (205). This provides all power to the robotic probe. It is fed by the unit battery (303).

A probe data cable (not individually depicted) is a USB compliant cable that connects the control unit to the robotic probe. It sends all control commands to the probe to engage motors, drive the wheels, deploy the plug, etc. It returns sensor data to the control unit from contact switches, the LED receptor, and the navigation camera. It is contained within the core of the umbilical tether (205).

In the pictured embodiment, a mechanical arm (402) rotates to spool and unspool the umbilical tether (205) for the purpose of deploying/retracting the probe to and from the ground. A tether deployment motor (401) rotates the tether reel arm (402).

FIG. 5 shows details of one embodiment of a feed mechanism for deploying the tether (205). The final vertical deployment of the tether from the housing assembly passes through the feed rollers (501) to ensure stability and uniform tension. These rollers can be passive, or could optionally be powered to assist in probe deployment and retraction. Mounting brackets (502) hold the rollers in place.

The umbilical tether and its internal cables do not feed directly into the probe interior. Instead, they connect via a custom plug. FIG. 6 shows the details of such a plug. The umbilical connector plug (602) inserts into the umbilical swivel connector (603). This allows the probe to be detached from the unit for possible service, cleaning, or replacement. It also serves as a safety mechanism, as the plug will disengage if sufficient pulling force is applied to the tether when the probe is locked into charging position. This could happen if, for example, the vehicle somehow rolls or is moved out of position while charging.

Two spring-loaded tension clamps (601) are installed on either side of the umbilical connector plug (602) and rest against the sides of the probe's umbilical swivel connector (603). This provides added tension to ensure that at least 100 pounds of pulling force is required to separate the tether from the probe (safety disengage). When the ends of the clamps are depressed, it becomes possible to disengage the umbilical connector plug with much less force (approximately 10 pounds). This is the method whereby the probe can be manually detached from the charging system.

### Robotic Charging Probe

The robotic charging probe (also referred to as the charging probe or simply the probe) is the maneuverable unit that docks with the charging station (103) to enable automated vehicle charging. It is a relatively simple robotic unit in that its power supply and control unit are external and are housed in the docking assembly (101). These are connected through the umbilical tether (205), which also conveys the primary vehicle charging cable. The unit itself weighs about 3-5 pounds, which may include some ballast to provide for additional maneuvering stability.

FIGS. 7A and 7B show top and bottom views of one embodiment of the probe. Some small parts are omitted for clarity. In particular, connecting bolts and screws, small wires, and contact sensors are not shown, but their presence and function can be readily inferred intuitively or by subsequent discussion of system functionality.

The outer shell (701) is a sturdy casing made primarily of a tough plastic or other similarly rugged material. Two drive wheels (702) are plastic/rubber wheels with a diameter of approximately 5 cm (2 inches). They have a traction tread suitable for traversing a flat concrete or asphalt surface.

The drive wheels (702) are mounted on spring-loaded hinges (706). The weight of the probe is sufficient to close the hinges to a position flush with the bottom surface of the probe. Contact sensors can then confirm the probe's successful deployment to ground level.

The drive wheel motors are under command of the control unit (301) and can rotate the corresponding wheels bi-directionally. They are variable speed motors that emphasize precision over top speed. Because the distance the probe must navigate is small (usually less than 2 feet) a top motor speed of 30 revolutions per minute is adequate. A lower motor speed of 2 revolutions per minute allows for precise positioning of the probe.

A front wheel (703) is a smaller, non-powered pivoting wheel. It is mounted on a spring loaded support with a contact sensor to confirm that the front of the probe is resting securely on the ground. The wheel serves as a third support point for the probe while freely allowing the probe to move or rotate in any direction.

FIG. 8 is an exploded view of the internal components of the charging probe. The upper cylindrical receptacle section of the umbilical swivel connector (603) widens into a hemisphere-shaped joint that fits into a ball connector socket (801) in the top center of the charging probe (see also FIG. 9). The connector can tilt to an angle of 45 degrees in any direction. This facilitates moving the probe from directly below the housing assembly in any direction while maintaining appropriate slack in the umbilical tether. The socket (801) provides a range of motion for the swivel connector (603) while not in a locked state.

At the bottom of the ball joint portion of the umbilical swivel connector (603) is a powered collar lock (802) that can extend pins (901) to lock the swivel connector (603) in a vertical orientation. This helps to maintain a rigid horizontal Probe position when it is being raised or lowered to/from the stowage bay.

A probe charging cable extension (606) extends the charging cable from the umbilical tether to the probe charging plug (804). It completes the charging circuit when the umbilical connector plug (602) is inserted into the umbilical swivel connector (603) and the charging plug (804) is connected to the charging station outlet.

A probe circuit board (806) serves as the connecting point between the control unit (301) and the probe sensor and motor components.

A probe power cable extension (605) is an internal extension from the swivel connector (603) to the probe circuit board (806). It provides power for all internal probe electrical components. In FIG. 8, only the endpoints of the wire are shown to aid visibility.

A probe data cable extension (604) is an internal extension from the swivel connector (603) to the probe circuit board (806). It carries commands from the control unit (301) and returns sensor data to the control unit. In FIG. 8, only the endpoints of the wire are shown to aid visibility.

The bottom center of the charging probe is covered by a protective retractable shield (704) that is only opened when the probe is in the final stages of connecting to the charging station.

A small electrical switch (805) opens and closes the probe retractable shield (704). It is powered and controlled via the probe circuit board (806).

There is a simple IR receiver (707) that detects IR signals transmitted by the charging station LED Emitters and reports them to the control unit. It connects to the probe circuit board (806).

FIG. 10 shows a detailed view of the probe charging plug components. The charging plug (804) is connected to the charging cable extension (606) and can be raised and lowered for insertion into the charging station outlet. It has three prongs with a flat middle section (to be secured by retaining clamps in the charging station). The ends of the prongs are rounded to ease plug insertion. The cylindrical charging plug is mounted on vertical tracks (1001) that allow the plug to be raised and lowered. The bottom of the plug has a short lip extension of approximately 0.3 cm (⅛″) that overlaps the outer perimeter of the charging station outlet.

A small, inexpensive probe camera (1002) is used by the precision navigation system to facilitate final positioning of the probe in preparation for plug insertion into the charging station outlet.

A plug deployment motor (803) is under the command of the control unit (301, via the probe circuit board 806) and drives the charging plug (804) up and down its vertical tracks (1001) for plug insertion and retraction.

### Charging Station

The Charging Station is the surface-mounted facility that provides electrical power for charging the EV/PHEV. There can be multiple variants of charging stations, corresponding to different capabilities and venues. At the low end would be a simple charging station for use in a home garage and at the high end would be a commercial high-capacity quick-charging station.

FIGS. 11A, 11B, 11C, and 11D show four embodiments of mounting strategies for charging stations. FIG. 11A shows a flush-mounted station with all components embedded just below the ground. FIG. 11C shows an extended platform deployment that obviates the need to penetrate the surface by housing the charging station in a platform that rises slightly above ground (approximately 2 inches) and would be straddled by a charging vehicle. The edges of the platform are gently sloped to allow the probe to navigate from floor level to the charging port, although it would also be typical for the initial deployment of the probe to be directly to the flat surface of the platform. FIG. 11B shows an additional variant of the above ground commercial mounting that requires a sufficiently strong platform to support the full vehicle weight and fully covers one or more parking/charging spaces.

FIG. 11D show an inexpensive station mounting that consists of a circular station with gradually sloping edges to allow the probe to navigate to the charging port. A standard electrical cord is connected to the station and plugs into a common 110 volt or 220 volt outlet. This last configuration is most appropriate for home use.

In describing the charging station components, not all components are applicable to all configurations. For example, a simple home system would not require an internet connection or any components associated with processing credit card transactions. It might also be simplified to exclude plug retaining clamps and some of the sensors and navigation aids that are less important in a home garage setting. This allows for a very low cost basic unit.

FIG. 12 diagrams the principal components of a typical commercial charging station. The external design components that supply the charging current and process financial transactions are outside the scope of this invention and are not detailed. Some small parts are omitted for clarity. In particular, connecting bolts and screws, small wires, and contact sensors are not shown, but their presence and function can be readily inferred intuitively or by subsequent discussion of system functionality.

The charging station port (1202) is securely sealed by an access door (1206) except when an authorized probe is in the process of docking with the port. This prevents unauthorized tampering as well as protects the port from all forms of contamination. This component may not be necessary for embodiments representing the simplest home charging units.

A small electrical motor (1215) opens and closes the charging station access door (1206). It is powered and controlled via a station control unit (1213).

The charging station port (1202) constitutes the entire opening exposed when the station access door (1206) is retracted. It is shown in more detail in FIG. 13. The primary exposed components are the charging outlet (1203) and a surrounding ring of infrared LED emitters (1301). A circular groove or channel surrounds the charging outlet (1203). All other internal components are sealed from exposure.

The charging outlet is a receptacle into which the probe charging plug (804) is inserted. One embodiment has three insertion holes arranged in a circular pattern matching the three prongs (1003) on the charging plug (804). The upper portion of each insertion hole is funnel-shaped to accommodate slight inaccuracy in the alignment of the plug with the outlet. In the exact center is one LED emitter, with a second just below it. These are instrumental in establishing the precise positioning and orientation of the probe prior to charging plug insertion. The perimeter of the charging outlet (1203) is demarcated by the surrounding groove and its diameter is slightly smaller than the probe charging plug (804). The outer lip of the plug rests in the groove and provides further protection to the connection point.

Three plug retaining clamps (1216) serve the dual purpose of securing a fully inserted plug to the charging outlet (1203) and providing a solid set of contact points to conduct the flow of charging current. In the simplest home stations, these clamps may be replaced with spring loaded clips that establish electrical contact with the plug. This would require minimal insertion force.

Retaining clamp switches (1211) move the retaining clamps (1216) back and forth between open and closed positions. They are powered and controlled by the station control unit (1213).

In addition to the two emitters (1301) located near the center of the charging outlet (1203), an additional ring of 6 LED emitters (1301) surround the port groove. Each emits a distinct flashing pattern controlled and powered by the station control unit (1213). These emitters are comparable to what would be found in a simple TV remote.

A station power cable (1207) provides the basic energy required to power the internal components of the charging station. It connects to the various motors, switches and sensors via the station control unit (1213) and is powered by an external power source (not pictured).

The charging station control unit (1213) contains the circuits required to control all operations of the charging station and also provides power to all internal components that require it.

A charging station communication module (1212) contains a wireless transceiver. Some embodiments may adhere to the BlueTooth convention, while others might employ a proprietary format. The communication module is responsible for communicating with any vehicle communications module (302) that is attempting to access the charging station.

The power to recharge the vehicle battery is conducted via a charging cable (1208) to power the charging outlet (1203). It is supplied by an appropriate external electrical source with specifications that may vary from installation to installation. It connects to the charging outlet (1203) via a charging cable activation switch (1209).

The charging cable activation switch (1209) enables current to flow from the charging cable (1208) to the charging outlet (1203). It is only activated when all authorizations have been completed and proper docking of the probe plug (804) has been confirmed. In the simplest home charging units, this component may not be required.

For commercial deployments, it may be necessary to authenticate driver access to the charging station by checking a remote data link. Likewise, credit/debit card transactions may need to be processed over a secure web connection. An Internet link module (1214) consists of a wired or wireless network card and connects to the station control unit (1213).

For open-air station deployments, there may be some concern regarding standing water accumulating within the charging outlet. A moisture detection sensor (1302) at the base of the port groove can detect the presence of standing water and potentially disable the activation of power flow if unacceptable conditions exist. This sensor is wired to the station control unit (1213).

As an optional additional precaution to protect the charging connection, a waterproof collar (1205) can be installed to close securely around the cylindrical housing of the charging plug. This prevents the seepage of any fluids while vehicle charging is underway. Note that this is probably not a significant concern. For covered or garage-based stations there is little issue with this. Outdoor installations are sealed by the station access door (1206) when not charging a vehicle. When the charging port (1202) is opened, the robotic charging probe (102) hovers directly above the port, protecting it from precipitation. More importantly, the vehicle itself provides substantial cover as charging occurs near the center underside of the vehicle. Any water entering the port would flow down the port groove and over the protruding lip of the charging plug (804), keeping it away from any electrical connection points. At the base of the port groove, drainage can be provided to remove any accumulation of water. Finally the moisture detector (1302) serves as the last resort to protect against any unsafe charging environments.

If the Waterproof Collar is present, a pair of collar switches (1204) is responsible for opening and closing the collar. They are powered and controlled by the station control unit (1213).

### Operation

### Probe Navigation Methodology

The coupling of the robotic charging probe plug (804) with the charging station outlet (1203) requires that the probe (102) be deployed to ground level and accurately navigated to the proper position directly above the outlet. The entire process encompasses multiple stages, each requiring different signal transmission and reception apparatus. These stages and the subsystems that support them are described in the following sections.

### Charging Station Detection

Whenever the vehicle speed drops below 5 MPH, the vehicle charging system engages station detection mode. This mode uses the primary wireless communications channel, which would most likely be BlueTooth or a proprietary protocol. In the case of BlueTooth 3.0, for example, the vehicle transmitter would use the Service Discovery Protocol (SDP) to identify the presence of a charging station in close proximity. The initial connection would be established in “Just Works” mode and would not require driver confirmation for the pairing. This does not preclude the potential for subsequent user interaction, such as authorizing a paid charging session.

The charging station remains in passive reception mode until it receives a wireless inquiry from a nearby vehicle system. It then responds by identifying itself and transmitting all necessary information to proceed with a potential charging session.

Once the vehicle has come to a complete stop for 30 seconds, if no station has been discovered, the vehicle charging system stops attempting to discover a compatible charging station. If a successful pairing has been established between the vehicle and a charging station, the system then engages the vehicle positioning system.

### Vehicle Positioning System

When a charging station has been detected in close proximity to the vehicle, the vehicle activates the coarse navigation system. The coarse navigation system is used during both the vehicle positioning stage and the probe's coarse navigation stage.

### Coarse Navigation System

The coarse navigation system is used to assist the driver in moving the vehicle within two feet of the optimal charging position. Following probe deployment, it then serves to guide the robotic probe within four inches of the docking port.

To determine position, the system uses a combination of inputs from multiple sensors. The control unit (1213, FIG. 12) housed in the charging deployment assembly (101, FIG. 1) collects this information and contains the software and hardware needed to execute the navigation and system control algorithms.

The probe provides status updates to the control unit via the data cable housed in the umbilical tether (205, FIG. 2). The probe contains simple accelerometers and wheel position sensors to monitor how far it has moved from its initial landing position.

In some embodiments, the control unit determines the location of the charging station through the use of radio frequency (RF) and/or ultrasound transmitters. These are located in known positions on the vehicle underbody and the charging station reports the reception of these signals back to the control unit via the primary communications channel. The control unit then uses triangulation techniques to determine the station position. The charging station receiver is located in a known position relative to its docking port. This may vary for different charging station configurations, but the exact geometry is transmitted by the charging station during the initial handshaking procedure.

The most likely candidates for the coarse positioning transmitters are pulse ultra wide band (UWB) radio transmitters or ultrasound transmitters. Use of optical sensors for the coarse navigation system is less preferable because of line of sight restrictions and the potential obscuration of optical transmitters/receivers by accumulated road dirt.

For triangulation purposes, received signal strength indicator (RSSI) techniques, time of arrival techniques, and signal direction detection would be combined to provide a best estimate of the charging station position relative to the vehicle. These methods are known to have sufficient accuracy to meet system requirements.

### Precision Navigation System

The precision navigation system is engaged once the coarse navigation system has completed its task. The precision navigation system is an optical system which is protected by retractable shields on the top of the charging station port and the bottom of the charging probe. Retraction of both of these cover shields must be confirmed by the control unit prior to engaging the precision navigation system.

The charging station port (1202, FIG. 12), once opened, reveals eight infrared LED transmitters in a well-defined pattern. Six of these are located around the perimeter of the open charging port, and two are near the center (see FIG. 13). The transmission pattern for each LED uniquely identifies it, so the detection of a single LED is sufficient to identify the position and orientation of the source signal.

The LED transmitter protocol can be quite simple and would likely be based on a typical emitter with a wavelength of 940 nm modulated at a frequency of 38 kHz. As little as 3 bits would be required to transmit a unique emitter ID, but to allow for error detection and header bits, an 8 or 16 bit signal is preferable. Each emitter could be allocated a 50 ms time slice to transmit its ID in sequence, followed by a 600 ms interval in which all emitters fire. This aids in synchronization and LED detection by the camera. Different embodiments might employ alternative protocols.

The LED signals are detected by the probe using a simple IR receiver (707, FIG. 7) complemented by a narrow field-of-view camera (1002, FIG. 10). The simple IR receiver on the bottom of the charging probe has a field of view with a footprint that approximates a circle with a 7.5 cm (3 inch) radius. If it is able to detect all eight LEDs, it can safely infer that it is very close to the center position of the charging port and can switch to the final phase of fine positioning using the camera. If less than eight LED signals are detected, the system can estimate its exact position by determining which of the LEDs are within the current field of view. The control unit then commands the probe to move to the proper position and iterates the process.

If no LED signals are detected, the process does not need to immediately abort. Instead, it goes into a seek mode in which the probe moves approximately 15 cm (6 inches) in each direction and checks if any LED signals are detected. If so, the fine tuning process proceeds. If not, the docking process fails, but even a coarse navigation error of up to 30 cm (12 inches) can still be corrected for by this process.

An inexpensive camera located at the center bottom of the charging probe plug guides the final positioning over the charging port. This can be a monochrome camera with a narrow field of view projecting to only about a 3 to 6 cm (1 to 2 inch) radius on the ground. Perfect positioning is indicated when the center LED on the charging probe is at the exact center of the camera field of view. For even a low resolution CCD or CMOS sensor, very precise positioning on the order of a few hundredths of an inch is achievable. The eighth LED, just below the center LED, confirms correct orientation.

Once precision navigation is complete, the charging probe plug is lowered into the port receptacle. Some small error in positioning is still tolerable, due to the rounded ends of the plug prongs (1003, FIG. 10) and the funnel shaped openings of the receptacle outlets (1303, FIG. 13). Up to 0.5 cm (0.2 inches) of tolerance can still be accommodated.

Slight misalignment of the prongs and outlet can be corrected by one of three methods. The simplest would be to allow the insertion process to self-correct. If the prongs rest in an off-center position within the receptacle funnels, the downward motion of the plug would cause the probe to lift slightly off the ground and the prongs would then slide down the cone surface into the receptacle holes. If this is considered unacceptable for any reason, the wheels on the probe could be mounted on a suspension that allowed for up to 0.5 cm (0.2 inches) of lateral displacement. Alternatively, the extensible plug assembly could be mounted on a suspension that allowed for a similar lateral displacement.

### Operating Modes

Most of the operational procedures for using the automatic robotic electric vehicle charging system are fully automatic and under control of the control unit that is part of the charging probe docking and deployment assembly. In some cases, user interaction may play a role in initiating certain operations.

The system can operate in different modes, depending on owner-defined configuration settings. These modes may be individually assigned based on charging station classification. Further definition of these terms follows.

Disengaged: the system is inactive and will not scan for available charging stations, nor will it initiate any deployment or charging operations.

Manual confirmation: the system will, under appropriate conditions, search for and identify compatible charging stations and, if found, will initiate the vehicle positioning feedback monitor. Explicit user confirmation is required, however, to authorize a connection and begin the deployment and docking procedures. When charging is complete, the system automatically disconnects and retracts the charging probe.

Delayed charging: the system will, under appropriate conditions, search for and identify compatible charging stations and, if found, will initiate a vehicle positioning feedback monitor (see FIG. 14 for a possible representation). Once the vehicle has been powered down, however, deployment of the probe will not commence immediately. Instead, the system will wait until a programmed time before connecting the probe and charging the battery. This might prove useful, for example, to take advantage of lower electricity rates when charging the vehicle overnight. Once charging is complete, the system automatically disconnects and retracts the charging probe.

Fully automatic: the system will, under appropriate conditions, search for and identify compatible charging stations and, if found, will initiate the vehicle positioning feedback monitor. Once all preconditions for successful deployment are met, the system automatically deploys the charging probe, connects to the charging station, and commences vehicle charging. When charging is complete, the system automatically disconnects and retracts the charging probe.

### Charging Station Classifications

Charging Stations are classified in three categories: home stations, free stations, and pay stations.

Home stations are normally located at the vehicle owner's home garage, this is a trusted charging station that requires no payment for an authorized vehicle to use.

A free station is a remote charging station that permits charging without payment for all vehicles or for specifically authorized vehicles.

A pay station is a remote public charging station that charges a fee for use. Fee structure and payment authorization information are exchanged between the station and the vehicle's charging system via wireless communication.

The operating mode can be independently set for each classification of charging station. For example, the owner might set automatic operation for free stations, delayed charging for the home station, and manual confirmation mode for pay stations.

Normal operation of the system encompasses six distinct operational phases. These are: phase I—system identification, phase II—vehicle positioning, phase III—authorization, phase IV—deployment and docking, phase V—vehicle charging, and phase VI—disconnection and retraction

### Phase I—System Identification

In order to facilitate a successful vehicle charging session, the charging apparatus onboard the vehicle must be in close proximity to a compatible charging station. The first phase in initiating this process is to detect and identify a nearby station under appropriate conditions. This communications process utilizes a short-range wireless protocol such as BlueTooth, or perhaps a proprietary protocol.

Charging stations normally function in a passive mode, awaiting the reception of a specific query signal that is transmitted from a vehicle seeking a charging session.

The onboard vehicle system is normally inactive when the vehicle is in motion or when the vehicle has been motionless for more than thirty seconds and no charging station has been detected. It is also inactive if the system has been placed in the disengaged mode.

Whenever the vehicle speed drops below 8 kph (5 mph) and the system has not been disengaged, it will send out a station query signal once per second until either the vehicle speed rises above 8 kph, the vehicle has come to a full stop for more than 30 seconds, or a station response signal has been received.

When a charging station detects a station query signal, it should immediately send out a station response signal. Based on the contents of the query message, the charging station should be able to immediately determine whether the sending vehicle is compatible with and authorized to use this particular charging station. The response message should include confirmation of such status.

This initial exchange triggers a more complete handshake between vehicle and station and provides information to the driver regarding the presence of and the status of the charging station.

### Phase II—Vehicle Positioning

Once initial communication has been established between the vehicle and the charging station, the system provides the driver with feedback regarding the proper positioning of the vehicle to successfully dock with the charging station. Due to the mobility of the robotic charging probe, there is a relatively lax requirement for precise positioning. The driver need only position the vehicle so that the probe location is within a radius of approximately 0.7 m (two feet) of the optimal position directly above the charging port.

Continual feedback is provided to the driver via the display on the control panel or remote control device. A sample display is shown in FIG. 14. Here, the small circle indicates the current horizontal position of the probe versus the ideal target position for the port. A numerical representation is also displayed. The circle is red if the current position is out of range, yellow if it is just within acceptable range (less than 0.7 m or 2 feet) and green if it is close to the optimal position (less than 0.35 m or 1 foot). Normally this simply requires the driver to pull slowly forward with the wheels straddling the station port and bring the car to a stop when the indicator turns green near the center of the target circle.

The data to feed this display comes from the system's coarse navigation component. The charging station detects and locates low power RF (and/or ultrasound) signals transmitted by the vehicle mounted unit to determine its position in space relative to the probe position.

### Phase III—Authorization

Authorization to use the Charging Station can commence immediately following the initial handshake connection and can proceed in parallel to the vehicle positioning operation.

For home or free stations, this simply consists of comparing the charging requirements of the vehicle to the capabilities of the station and optionally validating the vehicle identification number to a list of authorized vehicles. The authorization list is programmed by the station owner (who may also be the vehicle owner).

One possible setting is to allow all compatible vehicles. Another setting would be to only authorize connection for vehicles recorded in a local memory store, programmed by the owner. A third option would be to verify the ID versus an online list accessed via a secure web connection. This latter option would of course require the station to be equipped with the optional internet connection. This scenario might be useful, say, for a large employer that provides free charging stations for its employees who own electric or plug-in hybrid vehicles.

A paid station must perform the additional step of authorizing the charge method. Such a process is essentially identical to current “pay at the pump” charge methods at gas stations, except the charge card information would be stored electronically within the vehicle's control panel/device and transmitted via encrypted packets over the wireless link. PIN code entry can optionally be required. There is no need for the driver to leave the vehicle.

The driver's interaction with the automated recharging system is via one of several alternative remote control displays. In a fully integrated car system, all control functions could be accessible via an in-console touch screen display, which might also support other vehicle functions such as GPS navigation, entertainment, and cell phone operation. As alternatives, a dedicated remote control unit could be provided, or the driver could use a smart phone or portable tablet device to control the system.

### Phase IV—Deployment and Docking Sequence

The deployment and docking of the robotic charging probe proceeds only after a successful negotiation has been completed between the vehicle charging system and the charging station. This requires that the onboard charging system and the charging station have exchanged identifications, set appropriate charging parameters, and authenticated payment information (if required). It also requires that the vehicle is stationary, in parking mode (drive disengaged), and positioned within the target zone to facilitate docking (approximately a 0.7 m or 2 ft. radius). Once all of these conditions are met, the robotic probe is deployed and docked with the charging station. The principal events occurring in this process are as follows: the bay doors are opened, exposing the charging probe; the umbilical tether unspools, lowering the charging probe to the ground; the charging probe maneuvers directly above the charging station port; the charging probe lowers the plug connector into the port outlet and locks it in place; the charging station activates power and begins vehicle charging.

The entire process is expected to take less than 20 seconds between the initiation of the deployment procedure and the start of active charging.

### Phase V—Vehicle Charging

Once charging has commenced, all mechanical aspects of the probe system are inactive and electrical charge flows through the charging cable to the vehicle battery. The exact specifications of voltage and current flow are dependent on what the station is capable of providing and what the vehicle is capable of receiving. An acceptable combination will have been established during the identification phase (Phase I). Where multiple combinations are available, it is likely that the compatible combination that provides the fastest charging time will be selected.

It is the vehicle's responsibility to determine the current state of the battery charge level to determine when charging has been satisfactorily completed.

### Phase VI—Disconnection and Retraction

Disconnection and retraction of the robotic charging probe occurs once the charging of the vehicle battery is complete or upon specific request, i.e.—the driver either wants to start the vehicle motor or simply discontinue the charging process. The principal events occurring in this process are as follows: the charging station switches off power and finalizes paid transaction, if applicable; the charging station unlocks the plug connector and the charging probe removes the plug connector from the port; the charging probe maneuvers directly below the stowage bay; the umbilical tether re-spools, raising the probe into the stowage bay; the bay doors are closed and locked.

The entire process is expected to take less than 20 seconds between the initiation of the disconnect command and the completion of probe stowage. The vehicle is now ready to be driven.

### Other Embodiments

Certain details in the design of the proposed system are subject to revision or alternative implementation. This should not detract from the uniqueness of the concept and the fundamental innovation of a ground-based docking system for automatically recharging electric vehicles. Minor details such as the dimensions and placement of various components are of course subject to the final engineering process. Some potentially useful variations of the basic design are presently identified.

The essence of the concept is a maneuverable robotic probe that positions itself above a charging port and accurately inserts a plug into a receptacle. The shape and drive mechanism of the probe do not need to precisely match the description in this document. For example, a primarily rectangular configuration driven by a pair of tank-like treads might serve equally as well. The deployment housing would be suitably adapted to accommodate alternative geometric configurations of the probe.

An alternative means to achieve plug docking is to have the plug receptacle raised above ground (either permanently or on demand) with a horizontal insertion axis. This configuration might simplify some of the navigation and docking mechanisms, but this is a less preferred approach. This is because either a fixed or retractable above ground receptacle introduces additional reliability, maintenance, and safety concerns that are less problematic with a surface-mounted receptacle.

The placement, type, and number of motors required to lower the plug into the outlet are subject to a number of different embodiments. It is also possible to assist the insertion process by first lowering the body of the probe to the ground before proceeding with plug deployment. The upper section of the plug could consist of concentric, telescoping cylinders in order to increase the plug extension distance while reducing the overall height of the probe. The number, shape, and configuration of the prongs for either the charging connector or the umbilical connector may be modified without significantly affecting the overall design. The plug configuration could, for example, match existing plug configurations for manual recharging stations.

As already mentioned, either ultrasound or RF transmitters may be used for the coarse navigation system. Different configurations and placements are conceivable. The role of the charging station versus vehicle with regard to which transmits and which receives navigation signals are also reversible.

As an alternative to the horizontal spooling of the umbilical tether within the probe deployment assembly, a vertically oriented spool might also work effectively. The port doors may also have a different shape and/or be configured to slide rather than swing open.

It is possible, though probably less desirable, to house the control unit within the probe rather than the probe deployment assembly. Likewise, the battery (or a separate battery) could be contained within the probe.

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating there from. Therefore the present disclosure should not be limited to any single aspect, but rather construed in breadth and scope with the appended claims. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A system for charging an electric or hybrid electric vehicle comprising:
a) a deployment assembly affixed to the underside of said vehicle,
b) a robotic probe device securely housed in said deployment assembly,
c) means for releasing the robotic probe from the deployment assembly and lowering it to the ground via an attached cable tether,
d) a charging station installed at ground level providing a source of electrical power,
e) means for propelling the robotic probe to within close proximity of the charging station,
f) means for coupling the robotic probe with the charging station,
whereby said system will enable the recharging of the electric or hybrid vehicle's main battery.

2. The deployment assembly of claim 1 wherein hinged doors with locking pins are used to securely hold and protect the probe within the assembly when not deployed.

3. The deployment assembly of claim 1 wherein a spooled tether cable is uncoiled to lower the probe to the ground and convey the electrical charging circuit to the probe.

4. The charging system of claim 1 wherein the connection between the tether and the robotic probe is secured by a connector that can be released manually for intentional detachment or will release under greater tension for safety purposes.

5. The robotic probe of claim 1 wherein the connecting tether can be locked into a vertical position when lowering or raising the probe or freed to swivel when the probe is moving along the ground.

6. The charging station of claim 1 wherein a retractable cover protects and denies access to the charging outlet until suitable authorization has been obtained to plug into the outlet.

7. The charging station of claim 1 wherein a locking collar deploys around a connected plug to protect the internal mechanisms from moisture or other contaminants.

8. The charging system of claim 1 wherein the charging outlet receptacle has funnel-shaped insertion sockets to accommodate small errors when automatically coupling the charging plug into the socket.

9. A method for automatically recharging an electric or hybrid vehicle comprising the steps:
a) identifying the presence and characteristics of a compatible charging station,
b) deploying a device and navigating the device to within close proximity to a charging station,
c) coupling the device to the charging station,
d) transferring power to the vehicle charging circuit,
e) disengaging the charging device from the charging station when charging is complete and returning it to the vehicle.

10. The method of claim 9 wherein the charging station identifies itself to the vehicle via wireless transmission and exchanges authorization and utilization information.

11. The method of claim 9 wherein navigation of the charging device is handed off from a course navigation system to a precision docking system.

12. The method of claim 11 wherein an array of LED emitters transmitting unique signal patterns is used to identify the current position of the charging device relative to the charging outlet by aggregating the combined signals and inferring relative orientation based on any missing signals.

13. The method of claim 11 wherein precision insertion of the charging plug into the receptacle is facilitated by analyzing the position of a central LED within the field of view of a small camera.
